(19) United States
(12) Patent Application Publication
(10) Pub. No.: US 2017/0336657 A1
(43) Pub. Date: Nov. 23, 2017

(54) A HEATER FOR OPTICAL WAVEGUIDE AND A METHOD FOR CONFIGURING A HEATER FOR OPTICAL WAVEGUIDE

(71) Applicant: NEC Corporation, Tokyo (JP)

(72) Inventor: Hiroyuki YAMAZAKI, Tokyo (JP)

(21) Appl. No.: 15/527,521

(22) PCT Filed: Nov. 11, 2015
(86) PCT No.: PCT/JP2015/005628

§ 371 Date: May 17, 2017

(30) Foreign Application Priority Data
Nov. 18, 2014 (JP) 2014-233539

(51) Int. Cl. G02F 1/01

(52) U.S. Cl. CPC G02F 1/0147; G02F 2201/12

(57) ABSTRACT

In order to provide a technology in which a heater resistance can be reduced without increasing the thickness or width of a heater, a heater for optical waveguide comprises a heater formed near an optical waveguide, a first electrode formed in such a way as to electrically connect to the heater to which a first electric potential is applied, and a second electrode formed in such a way as to electrically connect to the heater to which a second electric potential different from the first electric potential is applied, wherein the first electrode and the second electrode are alternately to disposed in such a way that the heater is sectioned into two or more areas.

### TECHNICAL FIELD

The present invention relates to a heater for optical waveguide and a method for configuring a heater for optical waveguide and in particular, relates to a heater for optical waveguide having a structure for reducing a resistance of a heater and a method for configuring a heater for optical waveguide.

### BACKGROUND ART

Many kinds of functional optical devices such as an AWG (arrayed waveguide grating), a splitter, and the like are put into practical use by using a PLC (planar lightwave circuit). An optical phase shifter is an example of a component of which the functional optical device is composed. The optical phase shifter changes the phase of an optical signal by locally changing the temperature of the optical waveguide by using a heater formed near the optical waveguide. By using the optical phase shifter, various functional optical devices such as a VOA (variable optical attenuator), a wavelength variable laser, and the like can be fabricated by the PLC.

For example, in the VOA, a Mach-Zehnder interferometer with two arms can be fabricated by the PLC. By heating the heater of an optical phase shifter formed on the one arm of the Mach-Zehnder interferometer, a refractive index of the arm changes. As a result, the optical transmittance of the Mach-Zehnder interferometer can be controlled. Further, an optical switch in which a 2-input-2-output output coupler is used for the VOA is put into practical use.

A ring resonator may be used for the wavelength variable laser. In the wavelength variable laser, the optical phase shifter is formed near the optical waveguide of which the ring resonator is composed. The operation of varying the wavelength of the laser can be achieved by heating the heater disposed in the optical phase shifter. As described above, by dynamically changing the optical transmission state of the optical waveguide, the optical phase shifter can fabricate a PLC having various functions.

FIG. 5 and FIG. 6 are figures showing a structure of optical phase shifters 500 and 600 related to the present invention, respectively. FIG. 5 and FIG. 6 are a top view of the optical phase shifters 500 and 600, respectively. In FIG. 5 and FIG. 6, another optical waveguide which is not heated by the heater is not shown.

In FIG. 5, a linear optical waveguide 502 is formed on an optical waveguide substrate 501 and further, a linear heater 503 is formed just above the optical waveguide 502. Because the optical waveguide 502 is formed in a layer under the heater 503, it is represented by a dashed line. Electrodes 511 and 512 are disposed at the both ends of the heater 503. The electrodes 511 and 512 are lead-out electrodes for applying a voltage to the heater 503 that are made of an ordinary conductor. The voltage +V is applied to the electrode 511 disposed at one end of the heater 503 by an external power source. The electrode 512 is a GND (ground) electrode. The voltage +V is applied between the electrodes 511 and 512, an electric current flows through the heater 503, and whereby, the heater 503 generates heat. The optical waveguide 502 heated by heat generated by the heater 503 operates as an optical phase shifter and whereby, a light propagating through, the optical waveguide 502 is changed in such a way as to have a desired characteristic.

FIG. 6 shows an example of an optical phase shifter 600 in which a heater is formed along the optical waveguide of which a ring resonator is composed. In FIG. 6, a circular optical waveguide 602 is formed on an optical waveguide substrate 601 and a circular heater 603 is formed above the optical waveguide 602. Electrodes 611 and 612 are disposed at the both ends of the heater 603 in such a way that the electric current flows in the whole heater 603. The electrodes 611 and 612 are electrodes for applying a voltage to the heater 603 that are made of an ordinary conductor. The voltage +V is applied to the electrode 611 by the external power source, the electrode 612 is grounded, and whereby, the heater 603 generates heat and the optical waveguide 602 operates as the phase shifter.

With respect to the present invention, in patent literature 1, there is described a VOA having a structure in which the phase of the optical signal propagating through the optical waveguide is changed by heat generated by the heater. Further, in patent literature 2, there is described a wavelength variable laser device in which the heater is used in a wavelength variation unit.

### CITATION LIST

### Patent Literature

Japanese Patent Application Laid-Open No. 2005-141074 (paragraph [0030])

International Publication No. 2009/119284 (paragraph [0023])

### SUMMARY OF INVENTION

### Technical Problem

The length of the optical waveguide that has to be heated by the heater is different for each application or structure of the optical waveguide. For this reason, the heater length depends on the structure of the optical waveguide. On the other hand, when the optical waveguide is heated by a temperature at which the desired characteristic can be obtained by using a power supply which supplies a predetermined voltage, it is necessary to set a resistance of the heater (hereinafter, referred to as a “heater resistance”) to a value in the predetermined range. In order to set the heater resistance to a value in the predetermined range, it is necessary to appropriately set the thickness and the width of the heater at the time of designing the heater.

When the heater with long length is required but the heater resistance thereof is limited to a predetermined value, the thickness of the heater or the width of the heater has to be increased. However, in a common heater using a high melting point metal such as Pt (platinum), TiN (titanium nitride), or the like, when a film whose thickness is 0.5 μm or more is formed, a bad influence caused by distortion induced by film deposition or the like may occur. Further, when the width of the heater is increased, an area not intended to be heated on the optical waveguide substrate (for example, any part other than the part of the optical waveguide used for the optical phase shifter) is heated and whereby, a desired characteristic of the optical functional device may not be obtained. Thus, in the optical phase shifter using the heater, it is difficult to reduce the heater resistance and a setting range of the heater resistance is limited. Therefore, a problem in which a control range of an amount of heat generated by the heater is small occurs.

### Object of Invention

An object of the present invention is to provide a technology to increase a control range of an amount of heat generated by a heater without increasing the thickness or the width of the heater.

### Solution to Problem

A heater for optical waveguide of the present invention is characterized by comprising a heater formed near an optical waveguide, a first electrode which is formed in such a way as to be electrically connected to the heater and to which a first electric potential is applied, and a second electrode which is formed in such a way as to be electrically connected to the heater and to which a second electric potential different from the first electric potential is applied, wherein the first electrode and the second electrode are alternately disposed in such a way as to section the heater into two or more areas.

A method for configuring a heater for optical waveguide of the present invention is characterized by comprising: forming a heater near an optical waveguide, forming a first electrode to which a first electric potential is applied in such a way that the first electrode is electrically connected to the heater, and forming a second electrode to which a second electric potential different from the first electric potential is applied in such a way that the second electrode is electrically connected to the heater, wherein the first electrode and the second electrode are alternately disposed in such a way as to section the heater into two or more areas.

### Advantageous Effects of Invention

The present invention has an effect in which a heater resistance can be reduced without increasing the size of a heater.

### BRIEF DESCRIPTION OF DRAWINGS

FIG. 1 is a figure showing an example of a configuration of an optical phase shifter according to a first example embodiment.

FIG. 2 is a figure showing an example of a configuration of an optical phase shifter according to a second example embodiment.

FIG. 3 is a figure showing an example of a configuration of an optical phase shifter according to a third example embodiment.

FIG. 4 is a figure showing an example of a configuration of an optical phase shifter according to a fourth example embodiment.

FIG. 5 is a figure showing a configuration of an optical phase shifter related to the present invention.

FIG. 6 is a figure showing a configuration of another optical phase shifter related to the present invention.

### DESCRIPTION OF EMBODIMENTS

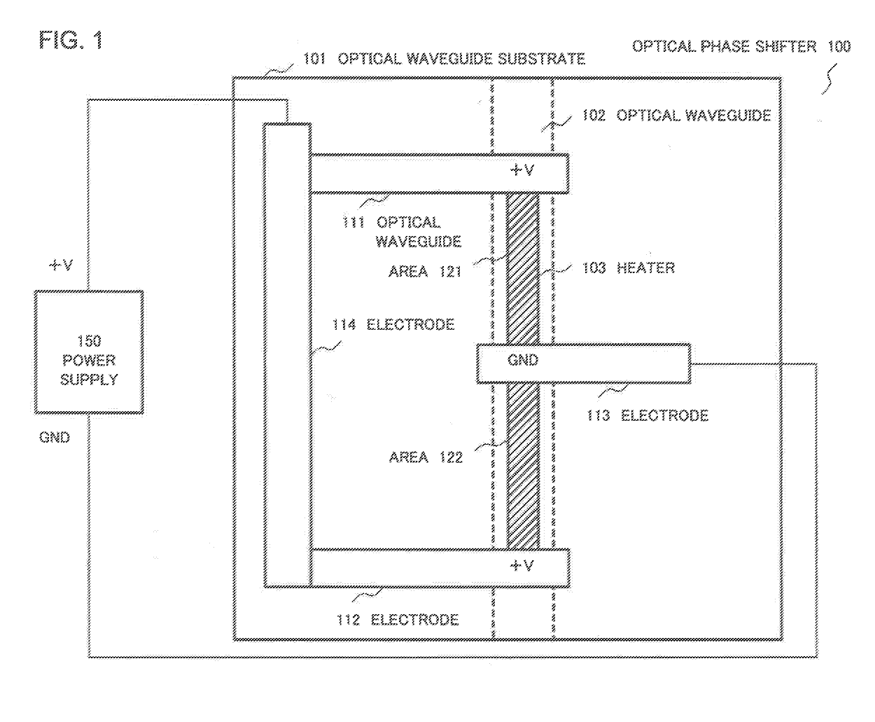

In the following example embodiment, an optical phase shifter to which the heater for optical waveguide of the present invention is applied will be described as an example of the functional optical device. Further, in FIG. 1 to FIG. 4 showing the example embodiment, other optical waveguides that are not intended to be heated by the heater and the connection between the other optical waveguides and the optical phase shifter are not shown. In other words, FIG. 1 to FIG. 4 show an example of a basic configuration of the optical phase shifter. The optical waveguides other than the optical phase shifter may be formed on the optical waveguide substrate. As a material of the optical waveguide substrate, for example, a quartzose material is used. However, the material of the optical waveguide substrate is not limited to this material.

### First Example Embodiment

FIG. 1 is a figure showing an example of a configuration of an optical phase shifter 100 according to a first example embodiment of the present invention. FIG. 1 is a top view of the optical phase shifter 100. A linear optical waveguide 102 is formed on an optical waveguide substrate 101 and further, a linear heater 103 is formed just above the optical waveguide 102. The heater 103 is indicated as a shaded part in FIG. 1. It is assumed that the resistance per unit length of the heater 103 is constant. Because the optical waveguide 102 is formed in a layer under the heater 103, it is represented by a dashed line.

The heater 103 may contain a material with relatively high resistivity such as Pt (platinum), TiN (titanium nitride), or the like. Electrodes 111, 112 and 113 are disposed at the both ends and the center of the heater 103, respectively. The heater 103 is sectioned into two areas 121 and 122 by three electrodes 111 to 113. However, the area 121 and the area 122 of the heater 103 are not electrically separated from each other. The electrodes 111 to 113 are lead-out electrodes for applying a voltage to the heater 103 that are made of an ordinary conductor. An electrode 114 is connected to the electrodes 111 and 112. The electrode 113 disposed at the center of the heater is an electrode at GND (ground) potential common to both the lead-out electrodes 111 and 112.

A power supply 150 is a direct-current power supply device used for heating the heater 103. The power supply 150 applies the same voltage (+V) to both the electrodes 111 and 112 located at the both ends of the heater 103 via the electrodes 114. By applying the voltage, the electric current flows from the electrodes 111 and 112 to the electrode 113. When the electric current flows in the heater 103, the heater 103 generates heat. When the heater 103 generates heat, the optical waveguide 102 located just under the heater 103 is heated and the light propagation characteristics of the optical waveguide 102 changes. In this way, the optical waveguide 102 operates as the optical phase shifter.

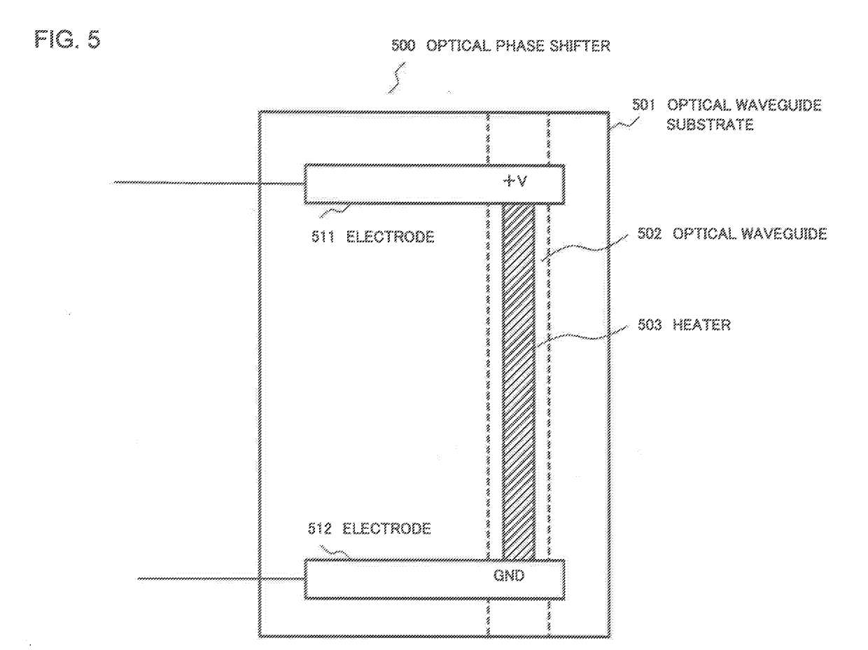

The electrode 113 may be disposed at the middle point between the electrodes 111 and 112. In this case, the heater resistance in the area 121 is equal to the heater resistance in the area 122. That is, it is assumed that the heater resistance between the electrode 111 and the electrode 112 is 2R, the heater resistance in each of the areas 121 and 122 is R. Here, as explained above, as shown in FIG. 5, when the voltage +V is applied to the electrode 111 and the electrode 112 is grounded without using the electrodes 113 and 114, the resistance between the electrode 111 and the electrode 112 is 2R. Accordingly, an amount of heat generated by the heater 103 is represented by the equation V²/(2R). On the other hand, by using this example embodiment, the heater resistance between the electrode to which the voltage +V is applied and the GND electrode which is grounded can be made half (R). Because two heaters each of which has a resistance R exist (in the areas 121 and 122, respectively), when the same voltage +V is applied to two heaters, the amount of heat generated by the heater 103 is represented by the equation 2×(V²/R). Thus, by disposing the electrode 113, the heater resistance in the area in which the voltage +V is applied can be reduced. Further, as a result, the amount of heat generated by the heater 103 can be made four times. When the voltage of the power supply 150 is changed between 0 and +V, a control range of the amount of heat generated by the heater can be expanded four times in comparison with a case in which the electrode 113 is not disposed. Further, the electrode 113 may not be necessarily disposed at the middle point between the electrodes 111 and 112. In this case, the heater resistance in the area 121 is not necessarily equal to the heater resistance in the area 122. However, the heater in the area 121 and the heater in the area 122 are connected in parallel. Accordingly, the resistance of the heater decreases when it is viewed from the power supply 150. That is, even when the heater resistance in each of all the areas is not equal to each other, the control range of the amount of heat generated by the heater can be expanded.

As described above, the optical phase shifter 100 according to the first example embodiment can reduce the heater resistance without increasing the size of the heater and the control range of the amount of heat generated by the heater 103 can be expanded.

### Second Example Embodiment

In the first example embodiment, the heater 103 is sectioned into two areas 121 and 122. When the heater 103 is sectioned into three or more areas, the heater resistance per sectioned area can be further reduced.

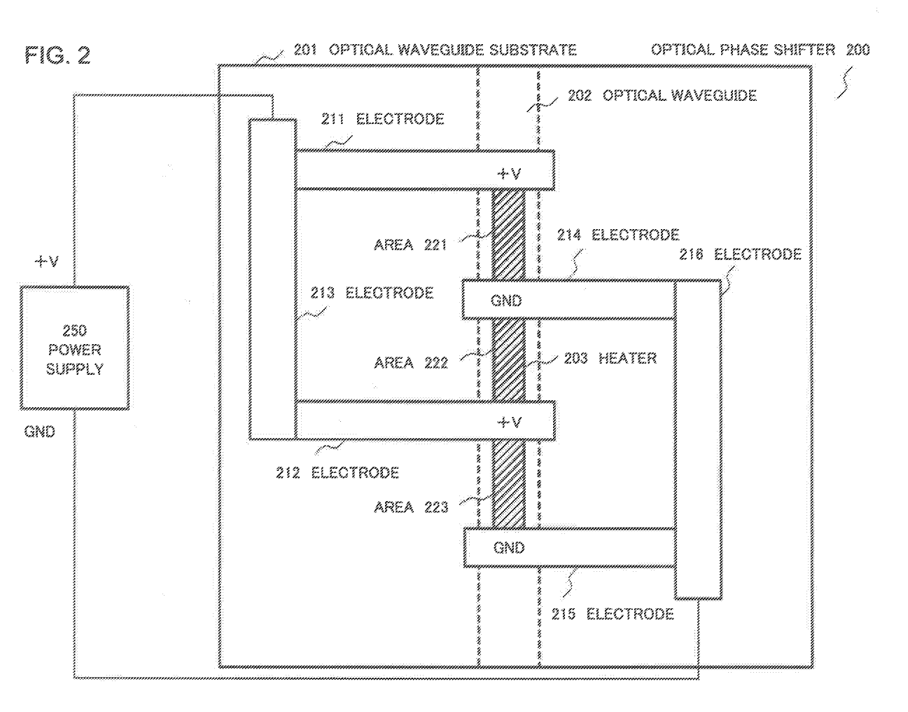

FIG. 2 is a figure showing an example of a configuration of an optical phase shifter 200 according to a second example embodiment of the present invention. FIG. 2 is a top view of the optical phase shifter 200. In FIG. 2, a linear optical waveguide 202 is formed on an optical waveguide substrate 201 and further, a linear heater 203 is formed just above the optical waveguide 202. The heater 203 is indicated as a shaded part in FIG. 2. It is assumed that the resistance per unit length of the heater 203 is constant. Because the optical waveguide 202 is formed in a layer under the heater 203, it is represented by a dashed line.

The heater 203 may contain a material with relatively high resistivity such as Pt, TiN, or the like. Electrodes 211, 212, 214 and 215 are disposed at the both ends and the positions between the both ends of the heater 103. The heater 203 is sectioned into three areas 221, 222 and 223 by four electrodes 211, 212, 214 and 215. However, the areas 221 to 223 are not electrically separated from each other. An electrode 213 is connected to the electrodes 211 and 212 and an electrode 216 is connected to the electrodes 214 and 215. The electrodes 211 to 216 are lead-out electrodes for applying a voltage to the heater 203 that are made of an ordinary conductor. The voltage +V is applied to the electrodes 211 and 212 by the power supply 250 and the electrodes 214 and 215 are grounded through the electrode 216.

The power supply 250 is a direct-current power supply device for heating the heater 203. The power supply 250 applies the same voltage (+V) to the electrodes 211 and 212 of the heater 203 via the electrode 213. When the voltage is applied by the power supply 250, the electric current flows from the electrodes 211 to the electrode 214 and the electric current flows from the electrode 212 to the electrodes 214 and 215. When the electric current flows in the heater 203, the heater 203 generates heat. When the heater 203 generates heat, the optical waveguide 202 located just under the heater 203 is heated and the light propagation characteristics of the optical waveguide 202 changes. In this way, the optical waveguide 202 operates as the optical phase shifter.

The electrodes 212 and 214 are disposed between the electrodes 211 and 215 in such a way as to equally section the heater 203 into three sections (areas) in length. In this case, the heater resistances in three areas 221 to 223 are equal to each other. That is, when it is assumed that the heater resistance between the electrode 211 and the electrode 215 is 3R, the heater resistance in each of the areas 221 to 223 is R. Because the electric potential difference between the adjacent electrodes on the heater 203 is V, the heater in each of the areas 221 to 223 of the heater 203 consumes the electric power of V²/R and the entire power consumption of the heater 203 (the amount of heat generated by the heater 203) is represented by the equation 3×V²/R. On the other hand, when the voltage +V is applied to the electrode 211 and the electrode 215 is grounded without the electrodes 212 and 214 are not used, the amount of heat generated by the heater is represented by the equation V²/(3R). That is, as shown in FIG. 2, when the electrodes 212 and 214 are disposed, the resistance of the heater driven by the voltage +V can be reduced one third and the amount of heat generated by the heater 203 can be increased by nine times. When the voltage of the power supply 250 is changed between 0 and +V, a control range of the amount of heat generated by the heater can be expanded nine times in comparison with a case in which the electrodes 212 and 214 are not disposed.

As described above, the optical phase shifter 200 according to the second example embodiment can reduce the heater resistance without increasing the size of the heater like the optical phase shifter 100 according to the first example embodiment and the control range of the amount of heat generated by the heater 203 can be expanded. Further, the electrodes 212 and 214 are not necessarily disposed in such a way as to equally section the heater 203 into three areas in length. In this case, the heater resistances in each of the areas 221 to 223 is not necessarily equal to each other. However, the heater in the area 221 and the heater in the area 222 are connected in parallel and the heater in the area 222 and the heater in the area 223 are connected in parallel. Therefore, the resistance of the heater decreases when it is viewed from the power supply 250. Namely, even when the heater resistance in each of all the areas is not equal to each other, the control range of the amount of heat generated by the heater can be expanded.

In the first and second example embodiments, the heater has a linear shape and the electrode is disposed in such a way that the heater is sectioned into two or more areas by the electrodes in a longitudinal direction of the heater. Generally, when the linear heater is equally sectioned into N areas and N sectioned areas, each of which has the same heater resistance are driven by the same voltage, the heater resistance of the sectioned area is equal to one-Nth of the heater resistance of the whole heater. When each of N sectioned heaters is driven by the voltage (+V in this example embodiment) that is equal to the voltage applied to the heater when the heater is not sectioned, the amount of heat generated by N sectioned heaters increases by N² times. Therefore, the control range of the amount of heat generated by the heater can be increased by N² times when the voltage supplied by the power supply is changed between 0 and +V.

### Third Example Embodiment

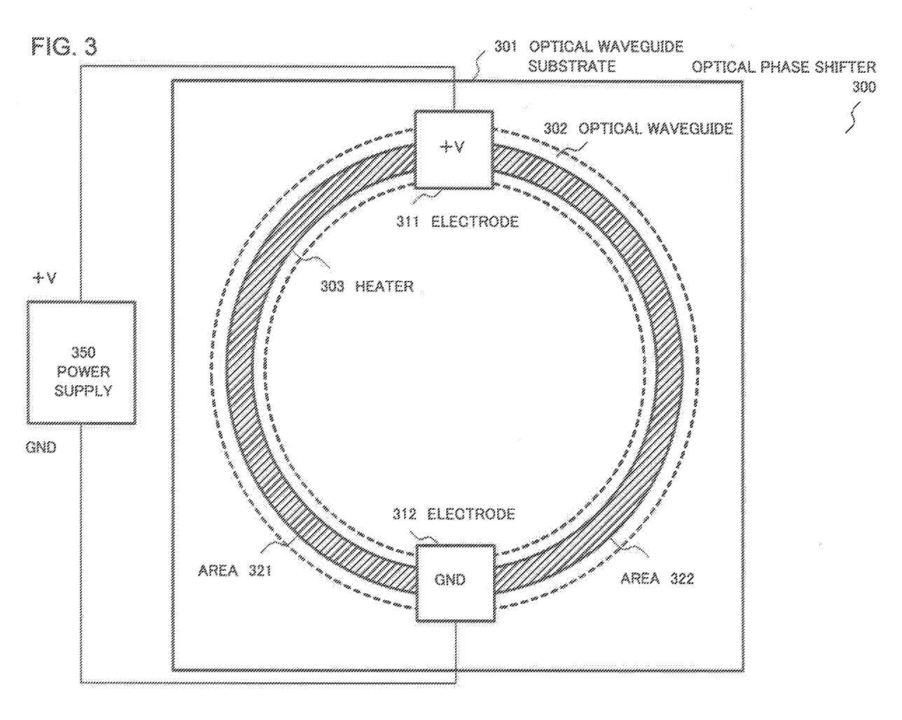

FIG. 3 is a figure showing an example of a configuration of an optical phase shifter 300 according to a third example embodiment of the present invention. FIG. 3 is a top view of the optical phase shifter 300. FIG. 3 shows an example of the optical phase shifter 300 in which the heater is formed along the circular optical waveguide as represented by a ring resonator. In the optical phase shifter 300, a circular optical waveguide 302 is formed on an optical waveguide substrate 301 and further, a circular heater 303 is formed just above the optical waveguide 302. The heater 303 is indicated as a shaded part in FIG. 3. It is assumed that the resistance per unit length of the heater 303 is constant. Because the optical waveguide 302 is formed in a layer under the heater 303, it is represented by a dashed line.

The heater 303 may contain a material with relatively high resistivity such as Pt, TiN, or the like. Electrodes 311 and 312 are disposed on the circular heater 303 in such a way that the electrodes face each other across the center of the circular heater 303. The electrodes 311 to 312 are lead-out electrodes for applying a voltage to the heater 303 that are made of an ordinary conductor. The heater 303 is sectioned into two areas 321 and 322 by two electrodes 311 and 312. However, the area 321 and the area 322 are not electrically separated from each other.

A power supply 350 is a direct-current power supply device for heating the heater 103. The power supply 350 applies the voltage +V to the heater 303 via the electrode 311. The electrode 312 is grounded. The heater 303 generates heat when the electric current flows from the electrode 311 to the electrode 312 through two areas 321 and 322 of the heater 303. When the heater 303 generates heat, the optical waveguide 302 located just under the heater 303 is heated and the light propagation characteristics of the optical waveguide 302 changes. In this way, the optical waveguide 302 operates as the optical phase shifter.

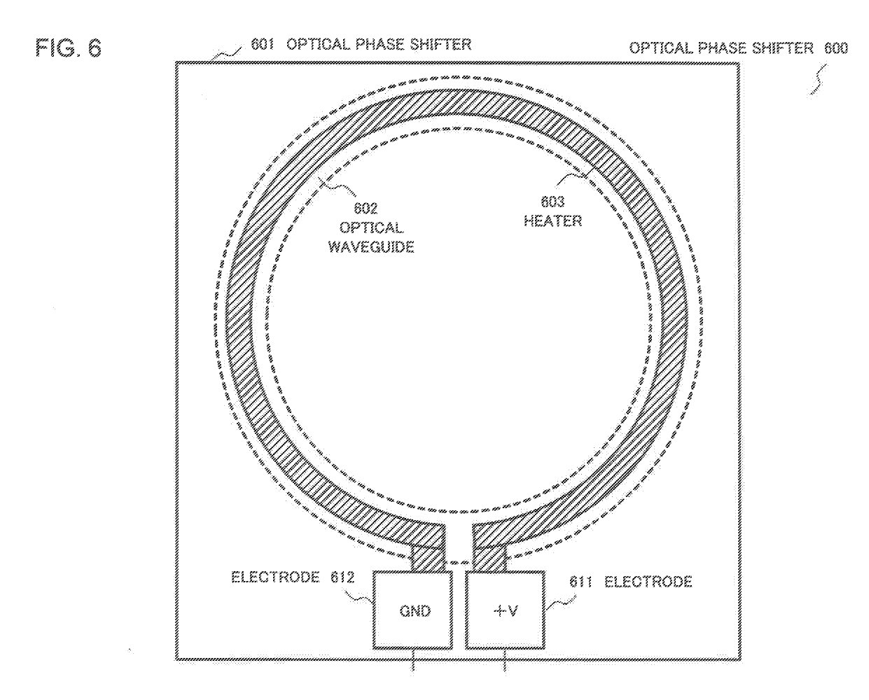

The electrodes 311 and 312 may be disposed in such a way that the circumference of the circular heater 303 is equally sectioned into two areas. In this case, the heater resistance in the area 321 is equal to the heater resistance in the area 322. That is, when it is assumed that the whole heater resistance of the circumference of the heater 303 is 2R, the heater resistance in each of the areas 321 and 322 is R. Thus, in this example embodiment, the electrodes 311 and 312 are formed on the circular heater 303 in such a way that the electrodes 311 and 312 face each other across the center of the circular heater 303. Accordingly, the resistance of the heater can be made half in comparison with a case in which the heater whose length is approximately equal to the length of the circumference of the circular heater is used as explained by using FIG. 6.

Here, in a case in which as shown in FIG. 6, the circular heater 603 is used as one heater without being sectioned into two or more areas and the voltage +V is applied to this circular heater 603, when it is assumed that the heater resistance of the circular heater 603 shown in FIG. 6 is 2R, the amount of heat generated by the circular heater 603 is represented by the equation V²/(2R).

On the other hand, in this example embodiment, the heater resistance between the electrode 311 at an electric potential of +V and the electrode 312 at an electric potential of 0 (GND) can be made half (R) compared with the heater resistance between the electrodes of the heater shown in FIG. 6. That is, two heaters each of which has a resistance of R exist (in the areas 321 and 322, respectively). Therefore, when the same voltage +V is applied to these two heaters in the areas 321 and 322, the amount of heat generated by these two heaters is represented by the equation 2×(V²/R). Thus, the electrodes 311 and 312 are disposed on the circumference of the heater 303 in such a way that the electrodes 311 and 312 face each other across the center of the circular heater 303, the circular heater 303 is sectioned into two areas 321 and 322, and whereby, the heater resistance in each area in which the voltage +V is applied can be reduced. Further, as a result, the amount of heat generated by the heater 303 increases four times. In addition, when the voltage supplied by the power supply 350 is changed between 0 and +V, a control range of the amount of heat generated by the heater 303 can be increased four times in comparison with a case in which the circular heater 303 is not sectioned into two areas 321 and 322. Further, the electrodes 311 and 312 may not be necessarily disposed in such a way that the circumference of the circular heater 303 is equally sectioned into two areas. In this case, the heater resistance in the area 321 is not necessarily equal to the heater resistance in the area 322. However, the resistance of the heater decreases when it is viewed from the power supply 350 because the heater in the area 321 and the heater in the area 322 are connected in parallel. That is, even when the heater resistance in each of all the areas is not equal to each other, the control range of the amount of heat generated by the heater can be expanded.

As described above, the optical phase shifter 300 according to the third example embodiment can reduce the heater resistance like the optical phase shifters 100 and 200 according to the first and second example embodiments without increasing the size of the heater and the control range of the amount of heat generated by the heater can be expanded.

### Fourth Example Embodiment

In the third example embodiment, the heater 303 has a structure in which the shape of the heater is circular and the heater is sectioned into two sections. When the heater 303 according to the third example embodiment is sectioned into three or more areas, the heater resistance per sectioned area can be further reduced.

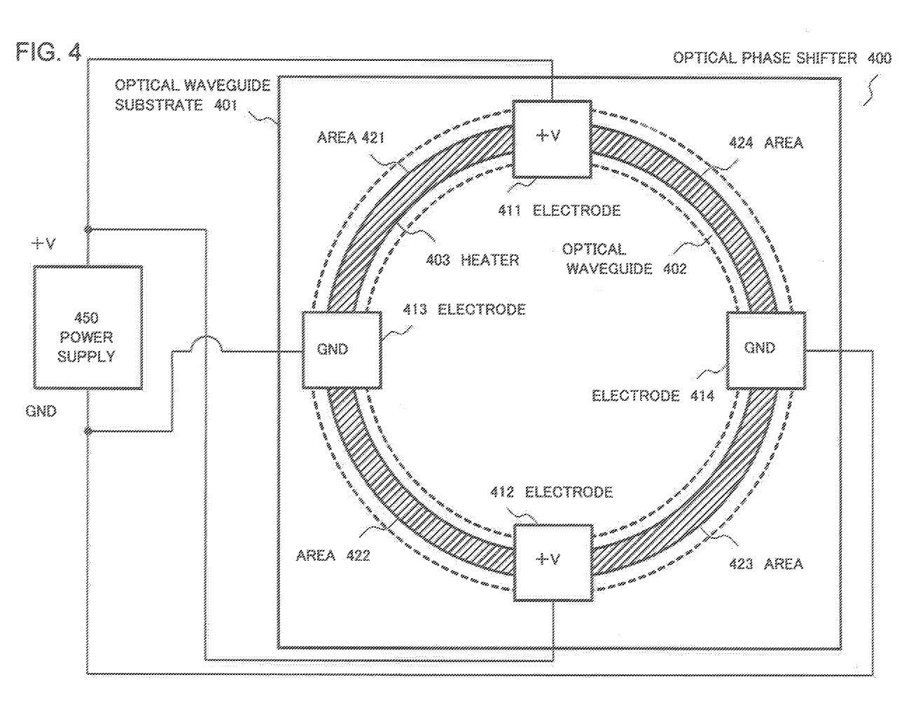

FIG. 4 is a figure showing a configuration of an optical phase shifter 400 according to a fourth example embodiment of the present invention. In FIG. 4, like FIG. 3, a circular optical waveguide 402 is formed on an optical waveguide substrate 401 and further, a circular heater 403 is formed just above the optical waveguide 402. The heater 403 may contain a material with relatively high resistivity such as Pt, TiN, or the like. The heater 403 is indicated as a shaded part in FIG. 4. It is assumed that the resistance per unit length of the heater 403 is constant. Because the optical waveguide 402 is formed in a layer under the heater 403, it is represented by a dashed line in FIG. 4.

On the other hand, in the fourth example embodiment, electrodes 411 to 414 are disposed to the heater 403 unlike the third example embodiment. The electrodes 411 to 414 are lead-out electrodes for applying a voltage to the heater 403 that are made of an ordinary conductor.

The heater 403 is sectioned into four areas 421 to 424 by four electrodes 411 to 414. However, the areas 421 to 424 are not electrically separated from each other. A power supply 450 is a direct-current power supply device for heating the heater 403. The voltage +V is applied to the electrodes 411 and 412 by the power supply 450. The electrodes 413 and 414 are electrodes at GND (ground) potential. When the voltage is applied by the power supply 450, the electric current flows from the electrodes 411 and 412 to the electrodes 413 and 414. When the electric current flows in the heater 403, the heater 403 generates heat. When the heater 403 generates heat, the optical waveguide 402 located just under the heater 403 is heated and the light propagation characteristics of the optical waveguide 402 changes. In this way, the optical waveguide 402 operates as the optical phase shifter.

The electrodes 411 to 411 may be disposed on the circumference of the heater 403 in such a way as to equally section the heater 403 into four areas. In this case, the heater resistances in the areas 421 to 424 are equal to each other. Because the electric potential difference between the adjacent electrodes on the heater 403 is V, when it is assumed that the resistance in each of the areas 421 to 424 is R, each area consumes the electric power of V²/R and the amount of heat generated by the whole heater 403 is represented by the equation 4×V²/R.

On the other hand, as described in FIG. 6, when the voltage +V is applied to the circular heater 603 that is formed as one heater in one area, when it is assumed that the heater resistance of the heater 603 shown in FIG. 6 is 4R, the amount of heat generated by the heater 603 is represented by the equation V²/(4R).

Thus, when the electrodes 411 to 411 are disposed on the circumference of the circular heater 403 and the heater 403 is sectioned into four areas 421 to 424, the resistance of the heater in each of the four areas that is driven by the voltage +V can be reduced. Further, when the electrodes 411 to 414 are disposed in such a way as to equally section the circular heater 403 into four areas and the voltage of the power supply 450 is changed between 0 and +V, the control range of the amount of heat generated by the heater can be increased sixteen (16) times in comparison with a case in which the circular heater 403 is not sectioned into four areas 421 to 424. Further, the electrodes 411 to 414 may not be necessarily disposed in such a way as to equally section the circumference of the heater 403. In this case, the heater resistance in each of the areas 421 to 424 is not necessarily equal to each other. However, when the heater in the area 421 and the heater in the area 424 are connected in parallel and the heater in the area 422 and the heater in the area 423 are connected in parallel, the resistance of the heater decreases when it is viewed from the power supply 450. That is, even when the heater resistance in each of all the areas is not equal to each other, the control range of the amount of heat generated by the heater can be expanded.

As described above, the optical phase shifter 400 according to the fourth example embodiment can reduce the heater resistance without increasing the size of the heater like the optical phase shifters 100, 200, and 300 according to the first to third example embodiments and the control range of the amount of heat generated by the heater 403 can be expanded.

As described in third and fourth example embodiments, when the circular heater is used, if the circular heater is sectioned into 2N areas (N is a natural number), each of which has the same heater resistance, the heater resistance in each area can be reduced 1/(2N) times. In the third example embodiment, N=1 and in the fourth example embodiment, N=2. When the heater in each area is driven by the voltage +V, the amount of heat generated by all the heaters can be increased (2N)² times. Namely, the control range of the amount of heat generated by the heater can be increased (2N)² times. Thus, the electrode may be disposed in such a way that the circumference of the circular heater is sectioned into two or more areas.

### Fifth Example Embodiment

The effect described in the first to fourth example embodiments is also brought by a heater for optical waveguide according to a fifth example embodiment. In the following explanation, the reference signs shown in FIG. 1 and the voltage (+V and GND) will be noted in the brackets. A heater for optical waveguide according to the fifth example embodiment includes a heater (103), the first electrodes (111 and 112), and the second electrode (113). The heater (103) is formed near the optical waveguide (102). The first electrodes (111 and 112) are formed in such a way as to electrically connect to the heater (103) and a first electric potential (+V) is applied to the first electrodes (111 and 112). The second electrode (113) is formed in such a way as to electrically connect to the heater (103) and a second electric potential (GND) different from the first electric potential (+V) is applied to the second electrode (113). The first electrodes (111 and 112) and the second electrode (113) are alternately disposed in such a way that the heater (103) is sectioned into two or more areas (121 and 122).

Further, by using the reference signs shown in FIG. 3 and the voltage (+V and GND), the heater for optical waveguide according to the fifth example embodiment can be described as follows. The heater for optical waveguide according to the fifth example embodiment includes the heater (303), the first electrode (311), and the second electrode (312). The heater (303) is formed near the optical waveguide (302). The first electrode (311) is formed in such a way as to electrically connect to the heater (303) and the first electric potential (+V) is applied to the first electrode (311). The second electrode (312) is formed in such a way as to electrically connect to the heater (303) and the second electric potential (GND) different from the first electric potential (+V) is applied to the second electrode (312). The first electrode (311) and the second electrode (312) are alternately disposed in such a way that the heater (303) is sectioned into two or more areas (321 and 322).

In the heater for optical waveguide according to the fifth example embodiment having such structure, the heater is sectioned into a plurality of areas and each area exists between the first electrode and the second electrode. Therefore, the heater resistance is reduced. Accordingly, the heater for optical waveguide according to the fifth example embodiment can reduce the heater resistance without increasing the size of the heater and the control range of the amount of heat generated by the heater can be expanded.

The invention of the present application has been described above with reference to the example embodiment. However, the invention of the present application is not limited to the above mentioned example embodiment. Various changes in the configuration or details of the invention of the present application that can be understood by those skilled in the art can be made without departing from the scope of the invention of the present application.

For example, in FIGS. 1 to 4, the heater exists just above the optical waveguide. However, a positional relationship between the heater and the optical waveguide can be arbitrarily determined when the characteristics of the optical waveguide can be changed to the desired one. That is, the positional relationship between the heater and the optical waveguide is not limited to the description of each example embodiment. Further, in FIGS. 1 to 4, the width of the optical waveguide located just under the heater is slightly greater than that of the heater. However, the width of the optical waveguide may be equal to or smaller than the width of the heater.

In FIG. 1 and FIG. 2, the optical waveguides 102 and 202 have a linear shape. However, the optical waveguides 102 and 202 may have a curved shape. In FIG. 3 and FIG. 4, the optical waveguides 302 and 402 have a circular shape. However, the optical waveguides 302 and 402 may have a true circle shape, an ellipse shape, another circular shape other than these shapes, or a rectangular shape.

Further, in the first to fourth example embodiments, a case in which the heater for optical waveguide is applied to the optical phase shifter is explained. However, the heater for optical waveguide of the present invention can be applied to another device other than the optical phase shifter if it is the optical waveguide device which uses a temperature change by the heater.

This application claims priority from Japanese Patent Application No. 2014-233539 filed on Nov. 18, 2014, the disclosure of which is hereby incorporated by reference in its entirety.

### REFERENCE SIGNS LIST

100, 200, 300, 400, 500, and 600 optical phase shifter
101, 201, 301, 401, 501, and 601 optical waveguide substrate
102, 202, 302, 402, 502, and 602 optical waveguide
103, 203, 303, 403, 503, and 603 heater
111 to 114, 211 to 216, 311, 312, and 411 to 414 electrode
511, 512, 611, and 612 electrode
121, 122, 221 to 223, 321, 322, and 421 to 424 area
150, 250, 350, and 450 power supply

1. A heater device for optical waveguide comprising:
a heater formed near an optical waveguide;
a first electrode formed in such a way as to electrically connect to the heater to which a first electric potential is applied; and
a second electrode formed in such a way as to electrically connect to the heater to which a second electric potential different from the first electric potential is applied,
wherein the first electrode and the second electrode are alternately disposed in such a way that the heater is sectioned into two or more areas.

2. The heater device for optical waveguide described in claim 1,
wherein the heater has a linear shape and the electrode sections the heater into two or more areas in a longitudinal direction of the heater.

3. The heater device for optical waveguide described in claim 1,
wherein the heater has a circular shape and the electrode sections the heater into two or more areas in the circumference direction of the heater.

4. The heater device for optical waveguide described in claim 1,
wherein one of the first electric potential and the second electric potential is ground potential.

5. The heater device for optical waveguide described in claim 1,
wherein the heater resistance in all the areas are equal to each other.

6. A functional optical device comprising:
an optical waveguide formed on an optical waveguide substrate; and
the heater device for optical waveguide described in claim 1 that is formed near and above the optical waveguide.

7. The functional optical device described in claim 6 further comprising a power supply device for applying a voltage to the first electrode and the second electrode.

8. A method for configuring a heater device for optical waveguide comprising:
forming a heater near an optical waveguide;
forming a first electrode to which a first electric potential is applied in such a way that the first electrode is electrically connected to the heater; and
forming a second electrode to which a second electric potential different from the first electric potential is applied in such a way that the second electrode is electrically connected to the heater,
wherein the first electrode and the second electrode are alternately disposed in such a way as to section the heater into two or more areas.

9. The heater device for optical waveguide described in claim 2,
wherein one of the first electric potential and the second electric potential is ground potential.

10. The heater device for optical waveguide described in claim 2,
wherein the heater resistance in all the areas are equal to each other.

11. The heater device for optical waveguide described in claim 3,
wherein one of the first electric potential and the second electric potential is ground potential.

12. The heater device for optical waveguide described in claim 3,
wherein the heater resistance in all the areas are equal to each other.

13. The heater device for optical waveguide described in claim 4,
wherein the heater resistance in all the areas are equal to each other.

14. A functional optical device comprising:
an optical waveguide formed on an optical waveguide substrate; and
the heater device for optical waveguide described in claim 2 that is formed near and above the optical waveguide.

15. A functional optical device comprising:
an optical waveguide formed on an optical waveguide substrate; and
the heater device for optical waveguide described in claim 3 that is formed near and above the optical waveguide.

16. A functional optical device comprising:
an optical waveguide formed on an optical waveguide substrate; and
the heater device for optical waveguide described in claim 4 that is formed near and above the optical waveguide.

17. A functional optical device comprising:
an optical waveguide formed on an optical waveguide substrate; and
the heater device for optical waveguide described in claim 5 that is formed near and above the optical waveguide.

18. The functional optical device described in claim 14 further comprising a power supply device for applying a voltage to the first electrode and the second electrode.

19. The functional optical device described in claim 15 further comprising a power supply device for applying a voltage to the first electrode and the second electrode.

20. The functional optical device described in claim 16 further comprising a power supply device for applying a voltage to the first electrode and the second electrode.
